(19) United States
(12) Patent Application Publication
(10) Pub. No.: US 2019/0300008 A1
(43) Pub. Date: Oct. 3, 2019

(54) CONTROL DEVICE, NON-TRANSITORY RECORDING MEDIUM, AND CONTROL METHOD

(71) Applicant: TOYOTA JIDOSHA KABUSHIKI KAISHA, Toyota-shi (JP)

(72) Inventor: Eisuke ANDO, Nagoya-shi (JP)

(73) Assignee: TOYOTA JIDOSHA KABUSHIKI KAISHA, Toyota-shi (JP)

(21) Appl. No.: 16/360,373

(22) Filed: Mar. 21, 2019

(30) Foreign Application Priority Data
Mar. 30, 2018 (JP) 2018-068833

(51) Int. Cl. B60W 50/029

(52) U.S. Cl. CPC B60W 50/029; H04W 4/44

(57) ABSTRACT

A control device which is mounted in a vehicle includes: a communication module configured to receive control information from an information processing device at a control time which is generated at predetermined intervals; a memory configured to store the received control information; and a processor configured to control the vehicle based on the received control information. The processor is configured to complement a loss in control information which is to be received at a next control time based on the control information stored in the memory when the loss in the control information which is to be received at the next control time has been detected.

### INCORPORATION BY REFERENCE

The disclosure of Japanese Patent Application No. 2018-068833 filed on Mar. 30, 2018 including the specification, drawings and abstract is incorporated herein by reference in its entirety.

### BACKGROUND

### 1. Technical Field

The disclosure relates to a control device, a non-transitory recording medium, and a control method.

### 2. Description of Related Art

Technology associated with control of a vehicle using information from an external device is known. For example, Japanese Unexamined Patent Application Publication No. 2017-041070 (JP 2017-041070 A) discloses a vehicle control device that acquires traveling environment information from an information management center and performs traveling control such as automatic driving. Japanese Unexamined Patent Application Publication No. 2017-169016 (JP 2017-169016 A) discloses a vehicle control system that includes a central control device connected to a vehicle via the Internet and a local control device connected to the vehicle via a local communication means and externally controls the vehicle.

### SUMMARY

In the related art associated with vehicle control using information from an external device, stability of vehicle control is not satisfactory. For example, from the viewpoint of stability of vehicle control, it is preferable that information be reliably transmitted to a vehicle from an external device at a necessary time. However, in the above-mentioned related art, transmission of information may be delayed or information may not be able to be transmitted, for example, due to an increase in processing load of the external device or a decrease in communication quality. In this case, for example, a decrease in stability of vehicle control such as a delay of movement of a vehicle or a decrease in movement accuracy may be caused. Accordingly, there is room for improvement in stability of vehicle control in the technique associated with vehicle control using information from an external device.

The disclosure provides a control device, a non-transitory recording medium, and a control method that can improve stability of vehicle control using information from an external device.

According to a first aspect of the disclosure, there is provided a control device which is mounted in a vehicle. The control device includes: a communication module configured to receive control information from an information processing device at a control time which is generated at predetermined intervals; a memory configured to store the received control information; and a processor configured to control the vehicle based on the received control information. The processor is configured to complement a loss in control information which is to be received at a next control time based on the control information stored in the memory when the loss in the control information which is to be received at the next control time has been detected.

According to a second aspect of the disclosure, there is provided a non-transitory recording medium storing a program causing a control device to perform operations. The control device is mounted in a vehicle. The operations includes: receiving control information from an information processing device at a control time which is generated at predetermined intervals; storing the received control information; controlling the vehicle based on the received control information; and complementing a loss in control information which is to be received at a next control time based on the stored control information when the loss in the control information which is to be received at the next control time has been detected.

According to a third aspect of the disclosure, there is provided a control method for a control device which is mounted in a vehicle. The control method includes: receiving control information from an information processing device at a control time which is generated at predetermined intervals; storing the received control information; controlling the vehicle based on the received control information; and complementing a loss in control information which is to be received at a next control time based on the stored control information when the loss in the control information which is to be received at the next control time has been detected.

With the control device, the non-transitory recording medium, and the control method according to the aspects, it is possible to improve stability of vehicle control using information from an external device.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating a configuration of a vehicle control system according to an embodiment of the disclosure;

FIG. 2 is a block diagram schematically illustrating a configuration of a control device which is mounted in a vehicle;

FIG. 3 is a block diagram schematically illustrating a configuration of an information processing device;

FIG. 4 is a block diagram schematically illustrating a configuration of a server;

FIG. 5 is a sequence diagram illustrating operations of the control device and the information processing device;

FIG. 6 is a flowchart illustrating a first operation of the control device;

FIG. 7 is a diagram illustrating an example of an operation of a vehicle based on second target information; and

FIG. 8 is a flowchart illustrating a second operation of the control device.

### DETAILED DESCRIPTION OF EMBODIMENTS

Hereinafter, embodiments of the disclosure will be described. Configuration of vehicle control system.

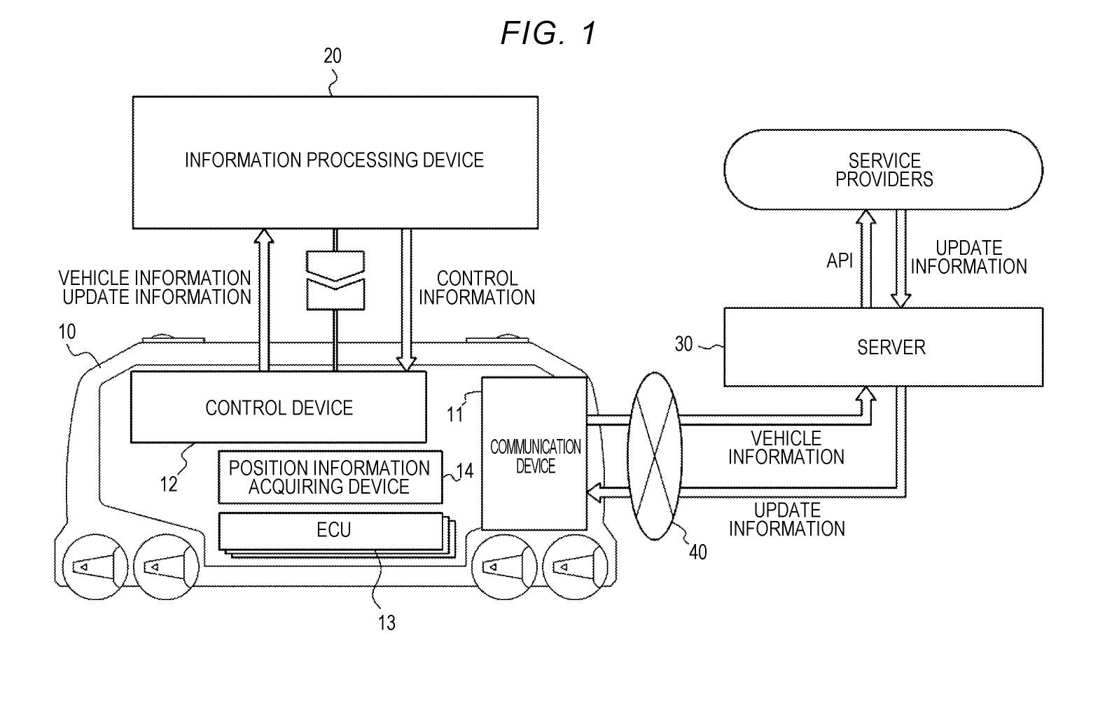

The outline of a vehicle control system 1 according to an embodiment of the disclosure will be described below with reference to FIG. 1. The vehicle control system 1 includes a vehicle 10, an information processing device 20, and a server 30. The vehicle 10 and the information processing device 20 can communicate with each other in a wired or wireless manner. The vehicle 10 and the server 30 can communicate with each other, for example, via a network 40 including a mobile communication network and the Internet. The vehicle control system 1 is used to provide a mobility service (MaaS: Mobility-as-a-Service). Service providers can provide mobility services such as ridesharing, a mobile hotel, and a mobile retail shop using the vehicle 10 and the information processing device 20.

The vehicle 10 is, for example, an automobile, but is not limited thereto and an arbitrary vehicle may be employed. For example, a service provider may mount an arbitrary facility corresponding to a purpose such as a facility with ridesharing specifications, a facility with hotel specifications, or a facility with retail shop specifications in an inner space of the vehicle 10. The information processing device 20 is an automatic driving kit in which a service provider can mount, for example, a computer having automatic driving control software installed therein and sensors such as a camera and a LIDAR pursuant to a purpose, but is not limited thereto and an arbitrary device may be employed. The information processing device 20 is mounted at an arbitrary position on the vehicle 10 such as a roof top of the vehicle 10. The server 30 includes one server unit or a plurality of server units that can communicate with each other. In this embodiment, it is assumed that the server 30 is one server unit for the purpose of simplification of description.

In the vehicle control system 1, the vehicle 10 and the information processing device 20 perform vehicle control of the vehicle 10 in cooperation with each other. Schematically, the information processing device 20 automatically generates control information using automatic driving control software and transmits the control information to the vehicle 10. The vehicle 10 performs vehicle control based on the received control information. Vehicle control is, for example, automatic driving but is not limited thereto. Automatic driving includes Levels 1 to 5 which are defined in the Society of Automotive Engineers (SAE), but is not limited thereto and may be arbitrarily defined. In this embodiment, it is assumed that the vehicle 10 can perform unmanned automatic driving (for example, automatic driving of Level 5 which is defined in the SAE). At least a part of an application programming interface (API) which defines specifications of control information is disclosed to service providers. Service providers can freely program automatic driving control software of the information processing device 20 using the disclosed API. Accordingly, service providers can provide an arbitrary mobility service by mounting facilities corresponding to a purpose in the interior space of the vehicle 10 and programming automatic driving control software using an API corresponding to the purpose. According to the vehicle control system 1, it is possible to promote technology development and creation of new mobility services by service providers.

In the vehicle control system 1, the server 30 serves as a mobility service platform. Schematically, the server 30 receives vehicle information from the vehicle 10 and stores the vehicle information in a database. The server 30 may store vehicle information received from a plurality of vehicles 10 as so-called big data. The server 30 generates management information, which is required for service providers to manage mobility services, for example, on management of a static state and a dynamic state of the vehicle 10 based on the stored information. A management API that acquires management information is disclosed, for example, to service providers. The service providers can easily receive necessary information from the server 30 via the management API. The server 30 can update the automatic driving control software of the information processing device 20 over the air (OTA) in response to a request from a service provider. According to the vehicle control system 1, a service provider can easily perform management of a mobility service, maintenance and update of the information processing device 20, and the like.

In this embodiment, as will be described later, the vehicle 10 receives control information from the information processing device 20 at a control time which is repeatedly generated at predetermined intervals (for example, several milliseconds). Here, it is conceivable that control information which is to be received by the vehicle 10 at a next control time may be lost due to causes such as an increase in processing load of the information processing device 20 and a decrease in communication quality between the information processing device 20 and the vehicle 10 (that is, the vehicle 10 cannot receive control information at a next control time normally). A loss in control information which is to be received by the vehicle 10 can cause a decrease in stability of vehicle control.

On the other hand, in this embodiment, when a loss in control information which is to be received at a next control time is detected, the vehicle 10 complements the loss by autonomously generating control information. According to this configuration, even when a loss in control information which is to be received by the vehicle 10 has occurred, it is possible to curb a decrease in stability of vehicle control. Accordingly, it is possible to improve stability of vehicle control in technology associated with vehicle control using information from an external device.

The configuration of the vehicle control system 1 will be described below in detail.

### Configuration of Vehicle

As illustrated in FIG. 1, the vehicle 10 includes a communication device 11, a control device 12, a plurality of electronic control units (ECUs) 13, and a position information acquiring device 14. The communication device 11, the control device 12, the ECUs 13, and the position information acquiring device 14 are connected to communicate with each other, for example, via an onboard network such as a controller area network (CAN) or a dedicated line.

The communication device 11 is an onboard communication device such as a data communication module (DCM). Specifically, the communication device 11 includes a communication module that is connected to a network 40. For example, the communication device 11 may include a communication module corresponding to a mobile communication standard such as 4^{th} generation (4G) or 5^{th} generation (5G). In this embodiment, the vehicle 10 is connected to the network 40 via the communication device 11.

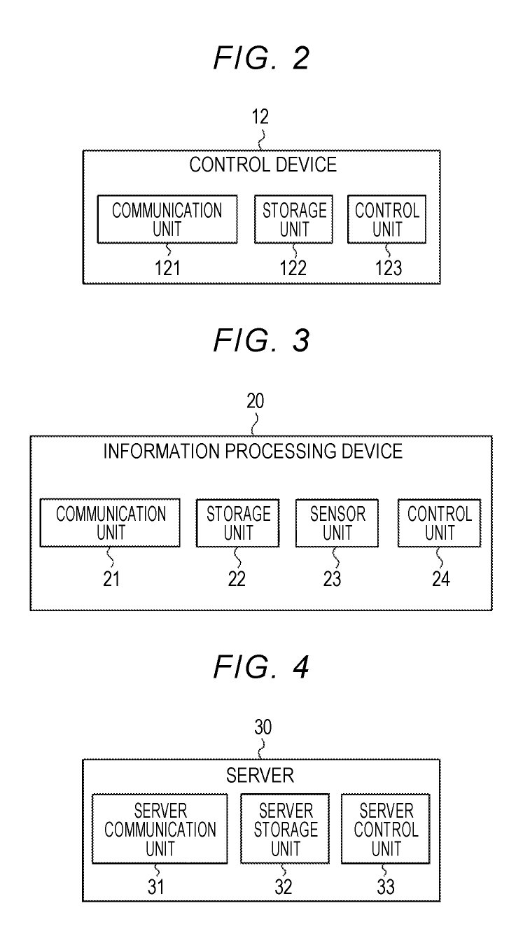

The control device 12 is a device that performs vehicle control based on control information from the information processing device 20. Vehicle control is performed by cooperation between the control device 12 and the ECUs 13. For example, as illustrated in FIG. 2, the control device 12 includes a communication unit 121, a storage unit 122, and a control unit 123.

The communication unit 121 includes a communication module that communicates with the information processing device 20, the communication device 11, the ECUs 13, and the position information acquiring device 14. For example, the communication unit 121 may include a communication module corresponding to a predetermined communication standard. An arbitrary communication protocol can be employed as a communication protocol which is used for the communication unit 121 to communicate with the information processing device 20. The communication unit 121 and the information processing device 20 may communicate with each other in a wired or wireless manner. For example, a representational state transfer (REST) based on a hypertext transfer protocol (HTTP) can be employed as a communication protocol between the communication unit 121 and the information processing device 20. For example, a CAN protocol can be employed as a communication protocol which is used for the communication unit 121 to communicate with the communication device 11, the ECUs 13, and the position information acquiring device 14. When a communication protocol with the information processing device 20 and a communication protocol with the communication device 11, the ECUs 13, and the position information acquiring device 14 are different from each other, the communication unit 121 converts data such that the data is suitable for the communication protocol of a communication destination.

The storage unit 122 includes one or more memories. In this embodiment, a “memory” is, for example, a semiconductor memory, a magnetic memory, or an optical memory but is not limited thereto. The memories included in the storage unit 122 may serve as, for example, a main storage device, an auxiliary storage device, or a cache memory. The storage unit 122 stores arbitrary information which is used for operation of the control device 12. For example, the storage unit 122 may store a system program, an application program, and identification information of the vehicle 10. Here, for example, identification information of an arbitrary device mounted in the vehicle 10 such as the communication device 11, the control device 12, or the position information acquiring device 14 may be used as identification information of the vehicle 10. Information stored in the storage unit 122 may be able to be updated with, for example, information acquired from the network 40 via the communication device 11.

The control unit 123 includes one or more processors. In this embodiment, a “processor” is a general-purpose processor or a dedicated processor specialized in specific processes but is not limited thereto. The control unit 123 controls the operation of the control device 12 as a whole.

For example, the control unit 123 receives control information from the information processing device 20 via the communication unit 121 at a control time which is repeatedly generated at predetermined intervals. The control time is synchronized between the vehicle 10 and the information processing device 20. The control unit 123 performs a vehicle control process whenever the control information is received. The vehicle control process includes a series of processes such as storage of control information, generation of a control command based on the control information, transmission of the control command to the information processing device 20, acquisition of vehicle information, and transmission of the vehicle information to the information processing device 20 as will be described later. Hereinafter, for the purpose of simplification of description, it is assumed that the vehicle control process is performed at each control time, but times at which individual processes included in the vehicle control process are performed does not need to necessarily coincide with the control times.

The vehicle control process which is performed at each control time will be described in detail. When control information is received from the information processing device 20 via the communication unit 121, the control unit 123 stores the control information in the storage unit 122. In this embodiment, control information includes a designated value of a control quantity or an operation quantity of the vehicle 10. The control quantity of the vehicle 10 is an output of the vehicle 10 which is a control object and can include a speed, acceleration, and an angular velocity, but is not limited thereto. The operation quantity of the vehicle 10 is an input of the vehicle 10 which is a control object and can include an accelerator operation amount, a brake depression pressure, and a steering angle, but is not limited thereto. The control information is not limited to the above-mentioned examples and may include arbitrary information which is used for vehicle control. For example, the control information may include information for designating an arbitrary operation of the vehicle 10 such as forward and rearward movement of the vehicle 10, right and left turns, acceleration/deceleration, or automatic driving to a destination depending on an API which is used by automatic driving software.

The control unit 123 performs vehicle control in cooperation with the ECUs 13 based on the received control information. Specifically, the control unit 123 generates a control command based on the received control information and transmits the control command to the ECUs 13. Vehicle control is performed by the ECUs 13 having received the control command.

More specifically, when a designated value of a control quantity (for example, a speed) is included in the received control information, the control unit 123 determines an operation quantity (for example, an accelerator operation amount) affecting the control quantity and a designated value thereof such that the control quantity becomes close to the designated value, and generates a control command including the designated value of the operation quantity. On the other hand, when a designated value of an operation quantity (for example, an accelerator operation amount) is included in the control information, the control unit 123 generates a control command including the designated value of the operation quantity. Then, the control unit 123 transmits the generated control command to the ECU 13 (for example, the ECU 13 for operating an accelerator) corresponding to the operation quantity. The operation quantity of the vehicle 10 is controlled such that it reaches the designated value indicated by the control command by the ECU 13 having received the control command. The control command is not limited to the operation quantity of the vehicle 10 and may include arbitrary information which is used for control of devices mounted in the vehicle 10 such as an audio device, an air-conditioning device, a display device, and an acoustic device.

Subsequently, the control unit 123 acquires vehicle information via the communication unit 121 and stores the acquired vehicle information in the storage unit 122. The vehicle information includes a measured value of a position and a measured value of a control quantity or an operation quantity of the vehicle 10 at the control time. The measured value of the position of the vehicle 10 is acquired from the position information acquiring device 14. The measured value of the control quantity or the operation quantity of the vehicle 10 is acquired from the ECUs 13. Then, the control unit 123 transmits the acquired vehicle information to the information processing device 20 via the communication unit 121. The vehicle information is used to generate control information in the information processing device 20.

The control unit 123 performs the vehicle control process (that is, the above-mentioned series of processes) at the control times. However, some processes included in the vehicle control process need not necessarily be performed at the control times. For example, acquisition and transmission of vehicle information in the above-mentioned processes may be performed at a control time which is requested from the information processing device 20.

The control unit 123 may receive target information on a target operation in the future which is to be performed by the vehicle 10 from the information processing device 20 via the communication unit 121 at a frequency which is lower than the occurrence frequency of the control time. The target information is information indicating a target operation in the future which is to be performed by the vehicle 10 in combination of a target value of a position and a target value of a control quantity or an operation quantity of the vehicle 10 at control times in the future. Accordingly, control is performed such that the vehicle 10 perform the target operation by controlling the position and the control quantity or the operation quantity of the vehicle 10 such that they match the target value indicated by the target information at the control times in the future. The target operation can include an arbitrary operation of automatic driving such as traveling along a predetermined route or lane change. For example, a trajectory indicating a route in the future on which the vehicle 10 is to travel may be used as the target information. The target operation is not limited to the operation of automatic driving and may include an arbitrary operation which can be performed by the vehicle 10. A specific example of the target information which is received by the communication unit 121 will be described later.

The control unit 123 determines whether a loss of control information which is to be received at a next control time has been detected. The loss can be caused due to certain causes such as an increase in processing load of the information processing device 20 or a decrease in communication quality between the information processing device 20 and the communication unit 121. Specifically, when control information cannot be received from the information processing device 20 even at a next control time, the control unit 123 determines that the loss has been detected. When it is determined that the loss has been detected, the control unit 123 complements the loss by autonomously generating new control information which is substituted for the lost control information based on the past control information stored in the storage unit 122. Three specific examples of the method of complementing a loss of control information will be described below.

In a first example, the control unit 123 complements the loss by extrapolation based on a plurality of pieces of the control information stored in the storage unit 122. For example, the control unit 123 determines an approximate function of a designated value of a control quantity or an operation quantity of the vehicle 10 included in each piece of control information stored in the storage unit 122, and autonomously generates new control information corresponding to a control time at which the loss has occurred using the approximate function.

In a second example, the control unit 123 complements the loss using an artificial intelligence (AI) based on a plurality of pieces of the control information stored in the storage unit 122. For example, the control unit 123 performs machine learning of a variation pattern of a designated value of a control quantity or an operation quantity of the vehicle 10 included in the plurality of pieces of the control information stored in the storage unit 122, and autonomously generates new control information corresponding to the control time at which the loss has occurred using the variation pattern.

In a third example, the control unit 123 stores target information received from the information processing device 20 in the storage unit 122 in advance. The control unit 123 identifies a target value of a control quantity or an operation quantity corresponding to the control time at which the loss has occurred out of target information stored in the storage unit 122. The control unit 123 autonomously generates new control information including the control quantity or the operation quantity of which the designated value is the identified target value as control information corresponding to the control time at which the loss has occurred.

Here, the control unit 123 may correct the generated new control information based on control information and/or vehicle information at one or more latest control times. For example, the control unit 123 may correct the designated value of the control quantity or the operation quantity included in the new control information based on a difference between the designated value of the control quantity or the operation quantity included in the control information stored in the storage unit 122 and the target value of the control quantity or the operation quantity included in the target information at one or more latest control times. For example, the control unit 123 may correct the designated value of the control quantity or the operation quantity included in the new control information based on a difference between the measured value of the position and the measured value of the control quantity or the operation quantity of the vehicle 10 indicated by the vehicle information stored in the storage unit 122 and the target value of the position and the target value of the control quantity or the operation quantity of the vehicle 10 included in the target information at one or more latest control times. Correction of control information is performed, for example, such that a rapid variation of the designated value of the control quantity or the operation quantity between an immediately previous control time and a next control time is relaxed.

Complementation of a loss of control information is not limited to the above-mentioned three examples and may employ an arbitrary method.

The control unit 123 transmits vehicle information acquired from the onboard network via the communication unit 121 along with the identification information of the vehicle 10 to the server 30 via the communication device 11 as described above. The vehicle information transmitted to the server 30 is stored in the server 30. Transmission of vehicle information to the server 30 may be performed, for example, periodically or whenever the vehicle 10 becomes a predetermined state (for example, ON/OFF of an accessory or an ignition). The vehicle information transmitted to the server 30 and the vehicle information transmitted to the information processing device 20 as described above may not necessarily include the same data. For example, data included in the former (for example, an accelerator operation amount) may not be included in the latter, or data included in the latter (for example, an automatic driving state) may not be included in the former.

When update information of software installed in the information processing device 20 is received from the server 30 via the communication device 11, the control unit 123 transmits the update information to the information processing device 20. The update information is used to update the software in the information processing device 20.

The plurality of ECUs 13 control the operation of the vehicle 10 in cooperation with the control device 12. Specifically, the plurality of ECUs 13 receive a control command based on the control information from the control device 12 and control the operation of the vehicle 10 in accordance with the control command. For example, the plurality of ECUs 13 controls an operation quantity of the vehicle 10 such that the operation quantity reaches a value indicated by the control command. At each control time, the plurality of ECUs 13 collects measured values of control quantities or operation quantities of the vehicle 10 from various sensors mounted in the vehicle 10 and transmit the measured values to the control device 12. Here, collection and transmission of the measured values of the control quantities or the operation quantities of the vehicle 10 may not necessarily be performed at each control time. For example, the collection and transmission of the measured values may be performed at intervals of two or more control times or may be performed in response to a request from the control device 12.

The position information acquiring device 14 includes one or more receivers corresponding to an arbitrary satellite positioning system. For example, the position information acquiring device 14 may include a global positioning system (GPS) receiver. The position information acquiring device 14 acquires a measured value of a position of the vehicle 10 as position information at each control time and transmits the acquired measured value to the control device 12. Here, acquisition and transmission of the measured value of the position of the vehicle 10 may not necessarily be performed at each control time. For example, the acquisition and transmission of the measured value may be performed at intervals of two or more control times or may be performed in response to a request from the control device 12.

### Configuration of Information Processing Device

As illustrated in FIG. 3, the information processing device 20 includes a communication unit 21, a storage unit 22, a sensor unit 23, and a control unit 24.

The communication unit 21 includes a communication module that communicates with the control device 12 of the vehicle 10 in a wired or wireless manner. In this embodiment, the information processing device 20 communicates with the control device 12 via the communication unit 21.

The storage unit 22 includes one or more memories. The memories included in the storage unit 22 may serve as, for example, a main storage device, an auxiliary storage device, or a cache memory. The storage unit 22 stores arbitrary information which is used for operation of the information processing device 20. For example, the storage unit 22 may store a system program, an application program, and automatic driving control software. Information stored in the storage unit 22 may be able to be updated with, for example, update information acquired from the control device 12 via the communication unit 21.

The sensor unit 23 includes one or more sensors that detect information on the operation of the information processing device 20 or the surrounding environment. The types and number of the sensors included in the sensor unit 23 are determined depending on a purpose by a service provider. For example, the sensor unit 23 may include arbitrary sensors such as a LIDAR, an acceleration sensor, an angular velocity sensor, a magnetic sensor, an atmospheric pressure sensor, an illuminance sensor, a temperature sensor, and an image sensor (a camera). The sensor unit 23 acquires information detected by the sensors as sensor information. For example, the sensor information of the sensor unit 23 may include detection information of the LIDAR, a captured image of the surrounding environment, acceleration, and an angular velocity of the vehicle 10, a magnetic field, and an atmospheric pressure.

The control unit 24 includes one or more processors. The control unit 24 controls the operation of the information processing device 20 as a whole.

For example, the control unit 24 receives vehicle information from the control device 12 via the communication unit 21 and stores the received vehicle information in the storage unit 22. As described above, the vehicle information includes the measured value of the position and the measured value of a control quantity or an operation quantity of the vehicle 10 at a control time. Reception and storage of the vehicle information are performed, for example, at each control time but may be performed at a control time which is requested to the control device 12 by the control unit 24.

The control unit 24 performs generation, transmission, and storage of control information using automatic driving software. An arbitrary algorithm can be employed for generation of control information depending on a purpose by a service provider.

For example, the control unit 24 generates target information on a target operation in the future which is to be performed by the vehicle 10 and stores the generated target information in the storage unit 22 in a frequency which is lower than the occurrence frequency of the control time. As described above, the target information is information indicating a target operation which is to be performed by the vehicle 10 using a combination of the target value of the position and the target value of a control quantity or an operation quantity of the vehicle 10 at each control time in the future. Here, the control unit 24 may correct the generated target information, for example, based on the sensor information from the sensor unit 23. When an obstacle or the like in the traveling direction of the vehicle 10 has been detected based on the sensor information from the sensor unit 23, the control unit 24 can correct the target information such the obstacle is avoided.

Subsequently, the control unit 24 identifies a target value of a control quantity or an operation quantity corresponding to a next control time out of the target information stored in the storage unit 22. The control unit 24 generates control information including the control quantity or the operation quantity with the identified target value as a designated value as control information corresponding to the next control time. At the next control time, the control unit 24 transmits the generated control information to the control device 12 via the communication unit 21 and stores the control information in the storage unit 22.

Here, the control unit 24 may correct the control information corresponding to the next control time based on control information and/or vehicle information at one or more latest control times. For example, the control unit 24 may correct the designated value of the control quantity or the operation quantity included in the control information corresponding to the next control time based on a difference between the designated value of the control quantity or the operation quantity included in the control information stored in the storage unit 22 and the target value of the control quantity or the operation quantity included in the target information at one or more latest control times. For example, the control unit 24 may correct the designated value of the control quantity or the operation quantity included in the control information corresponding to the next control time based on a difference between the measured value of the position and the measured value of the control quantity or the operation quantity of the vehicle 10 indicated by the vehicle information stored in the storage unit 22 and the target value of the position and the target value of the control quantity or the operation quantity of the vehicle 10 included in the target information at one or more latest control times. Correction of control information is performed, for example, such that a rapid variation of the designated value of the control quantity or the operation quantity between an immediately previous control time and a next control time is relaxed.

### Configuration of Server

As illustrated in FIG. 4, the server 30 includes a server communication unit 31, a server storage unit 32, and a server control unit 33.

The server communication unit 31 includes a communication module that is connected to the network 40 in a wired or wireless manner. In this embodiment, the server 30 is connected to the network 40 via the server communication unit 31.

The server storage unit 32 includes one or more memories. The memories included in the server storage unit 32 may serve as, for example, a main storage device, an auxiliary storage device, or a cache memory. The server storage unit 32 stores arbitrary information which is used for operation of the server 30. For example, the server storage unit 32 may store a system program, an application program, and a database. Information stored in the server storage unit 32 may be able to be updated with, for example, information acquired from the network 40 via the server communication unit 31.

The server control unit 33 includes one or more processors. The server control unit 33 controls the operation of the server 30 as a whole.

For example, the server control unit 33 receives vehicle information from the vehicle 10 via the server communication unit 31. The server control unit 33 stores vehicle information in the database of the server storage unit 32. Information stored in the database may be used for a variety of finance such as lease or insurance, vehicle maintenance linked with a vendor, or the like of the vehicle 10. The server control unit 33 generates management information on management of a static state and a dynamic state of the vehicle 10 or the like based on the stored information and provides the generated management information to a service provider in response to a request via a management API.

The server control unit 33 may transmit update information of a system program, an application program, automatic driving software, and the like of the information processing device 20 to the vehicle 10 via the server communication unit 31. The vehicle 10 receives the update information via the communication device 11 and transmits the update information to the information processing device 20 via the control device 12. The information processing device 20 updates the system program, the application program, the automatic driving software, and the like based on the received update information.

### Operation Flow of Vehicle Control System

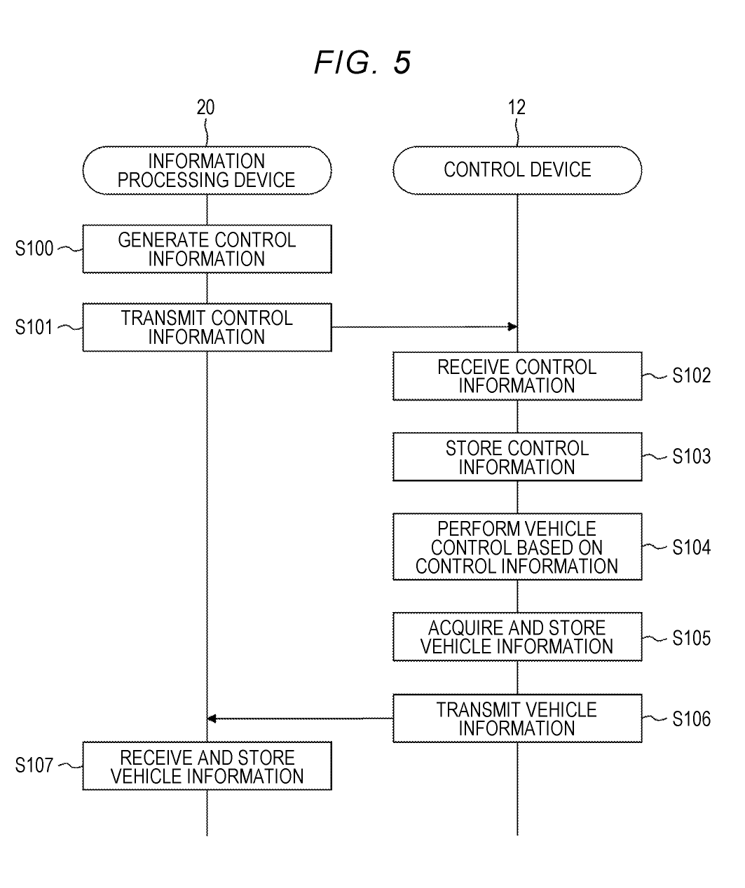

A flow of operations of the control device 12 and the information processing device 20 in the vehicle control system 1 will be described below with reference to FIG. 5. The operation flow includes operations of the above-mentioned vehicle control process and is periodically performed at control times.

Step S100: The information processing device 20 generates control information, for example, using target information. Here, the information processing device 20 may correct the generated control information, for example, based on control information and/or vehicle information at one or more latest control times.

Step S101: The information processing device 20 transmits the control information in Step S100 to the control device 12.

Step S102: The control device 12 receives control information from the information processing device 20.

Step S103: The control device 12 stores the control information in Step S102.

Step S104: The control device 12 performs vehicle control in cooperation with the ECUs 13 based on the control information in Step S102. Specifically, the control device 12 generates a control command based on the control information and transmits the generated control command to the ECUs 13. Vehicle control is performed by the ECUs 13 having received the control command.

Step S105: The control device 12 acquires and stores the vehicle information.

Step S106: The control device 12 transmits the vehicle information in Step S105 to the information processing device 20.

Step S107: The information processing device 20 receives and stores the vehicle information from the control device 12.

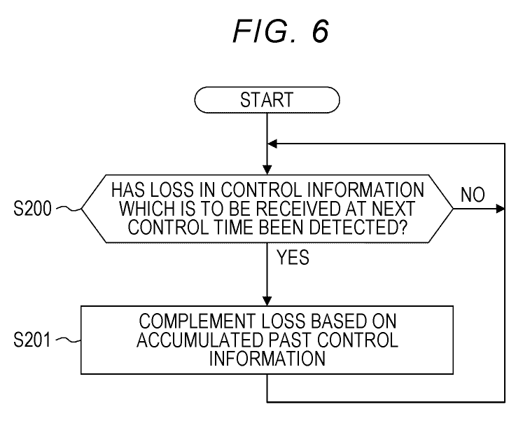

A flow of a first operation of the control device 12 will be described below with reference to FIG. 6. The first operation includes an operation of detecting a loss of control information and is performed in parallel with Steps S100 to S107.

Step S200: The control unit 123 of the control device 12 determines whether a loss of control information which is to be received at a next control time has been detected. When it is determined that the loss has not been detected (NO in Step S200), the operation flow returns to Step S200. On the other hand, when it is determined that the loss has been detected (YES in Step S200), the operation flow transitions to Step S201.

Step S201: The control unit 123 complements the loss detected in Step S200 by autonomously generating control information which is substituted for the lost control information based on the past control information stored in the storage unit 122.

As described above, in the vehicle control system 1 according to this embodiment, when a loss of control information which is to be received at a next control time has been detected, the control device 12 which is mounted in the vehicle 10 complements the loss by autonomously generating control information. According to this configuration, even when a loss of control information which is to be received by the vehicle 10 has occurred, it is possible to curb a decrease in stability of vehicle control. Accordingly, it is possible to improve stability of vehicle control in techniques associated with vehicle control using information from an external device.

While the invention has been described above with reference to all the drawings and the embodiment, it should be noticed by those skilled in the art that the invention can be easily modified and corrected in various forms based on the present disclosure. Accordingly, it should be noticed that such modifications and corrections are included in the scope of the invention. For example, the means and the functions included in the steps can be rearranged unless conflicting logically, and a plurality of means or steps may be combined into one means or step or one means or step may be divided.

For example, in the above-mentioned embodiment, the control device 12 receives target information (hereinafter referred to as “first target information”) on a target operation (hereinafter referred to as a “first target operation”) in the future which is to be performed by the vehicle 10 from the information processing device 20. In a modified example of this embodiment, the control device 12 may generate second target information on a second target operation in the future which is to be performed by the vehicle 10 prior to the first target operation or may receive the second target information from an external device such as the server 30 or another vehicle 10 which is located nearby. The second target information is generated or received, for example, when it is necessary to change the first target operation of the vehicle 10 due to causes such as roadwork, traffic accidents, or presence of an obstacle.

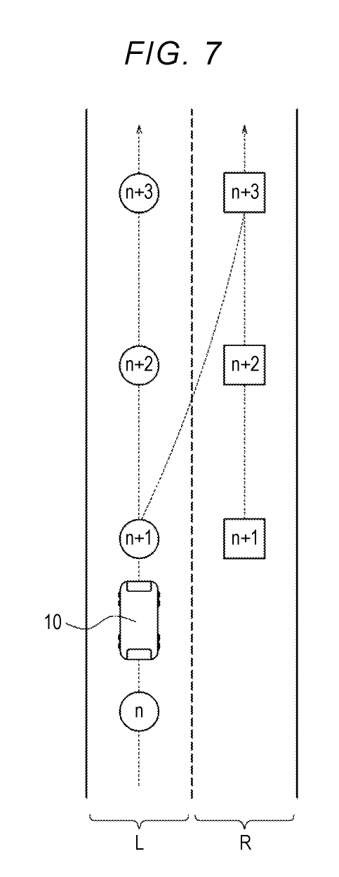

For example, circular nodes illustrated in FIG. 7 denote target values of the position of the vehicle 10 indicated by the first target information at four control times corresponding to time k=n, n+1, n+2, and n+3. In FIG. 7, a current time k satisfies n<k<n+1 and the vehicle 10 is located between the circular nodes n and n+1. The first target operation of the vehicle 10 corresponding to the first target information is an operation of traveling on a left lane L. Here, for example, when a sensor such as a millimeter wave radar is mounted in the vehicle 10, the control device 12 can detect an obstacle based on the sensor information from the sensor. In the example illustrated in FIG. 7, for example, when the control device 12 detects an obstacle in the front of the vehicle 10 on the left lane L, the control device determines, for example, an operation of traveling on a right lane R as a second target operation in order to avoid the obstacle and generates second target information corresponding to the second target operation. Alternatively, the control device 12 may receive the second target information from an external device. Rectangular nodes illustrated in FIG. 7 denote target values of the position of the vehicle 10 indicated by the second target information at three control times corresponding to times k=n+1, n+2, and n+3.

When the second target information is generated or received, the control device 12 performs vehicle control such that the operation of the vehicle 10 becomes close to the second target operation instead of the first target operation without using control information which is to be received from the information processing device 20 at a next control time. Specifically, the control device 12 autonomously generates new control information which is substituted for the control information which is to be received from the information processing device 20 and performs vehicle control. Here, the control device 12 may slowly bring the operation of the vehicle 10 close to the second target operation from the first target operation such that the position and a control quantity or an operation quantity of the vehicle 10 vary rapidly over a predetermined criterion. In the example illustrated in FIG. 7, the vehicle 10 slowly changes the lane from the left lane L to the right lane R such that the operation of the vehicle 10 matches the second target operation at time k=n+3.

The control device 12 transmits the generated or received second target information to the information processing device 20. The information processing device 20 overwrites the received second target information as new first target information or corrects the first target information to the second target information. According to this configuration, the control device 12 performs vehicle control based on the new control information which has been autonomously generated at some control times and then can perform vehicle control based on control information from the information processing device 20 similarly to the above-mentioned embodiment.

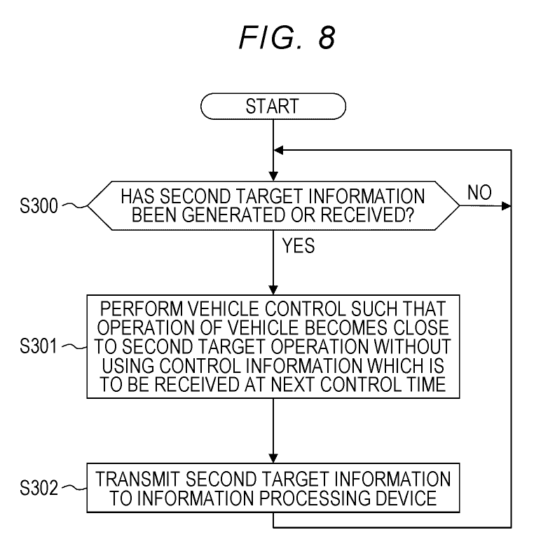

A flow of a second operation of the control device 12 according to a modified example of the embodiment will be described below with reference to FIG. 8. The second operation includes an operation of determining generation or reception of the second target information and is performed in parallel with Steps S100 to S107 and Steps S200 to S201 in the above-mentioned embodiment.

Step S300: The control unit 123 of the control device 12 determines whether the second target information has been generated or received. When it is determined that the second target information has not been generated nor received (NO in Step S300), the operation flow returns to Step S300. On the other hand, when it is determined that the second target information has been generated or received (YES in Step S300), the operation flow transitions to Step S301.

Step S301: The control unit 123 performs vehicle control of the vehicle 10 such that the operation of the vehicle 10 becomes close to the second target operation instead of the first target operation without using control information which is to be received at a next control time.

Step S302: The control unit 123 transmits the second target information in Step S300 to the information processing device 20 via the communication unit 121.

For example, a general-purpose electronic device may be caused to function as the control device 12 according to the above-mentioned embodiment. Specifically, a program in which process details for implementing the functions of the control device 12 according to the embodiment are described is stored in a memory of the electronic device (a non-transitory recording medium) and the program is read and executed by a processor of the electronic device. Accordingly, the configuration according to this embodiment can also be embodied as a program which can be executed by a processor.

The network 40 in this embodiment includes an ad hoc network, a local area network (LAN), a metropolitan area network (MAN), a cellular network, a wireless personal area network (WPAN), a public switched telephone network (PSTN), a terrestrial wireless network, an optical network, another network, or a combination of some thereof in addition to the above-mentioned examples. Examples of elements of a wireless network include an access point (for example, a Wi-Fi access point) and a femtocell. A wireless communication device can be connected to a wireless network using Wi-Fi (registered trademark), Bluetooth (registered trademark), cellular communication techniques, or other radio techniques and technical standards.

What is claimed is:

1. A control device which is mounted in a vehicle, comprising:
a communication module configured to receive control information from an information processing device at a control time which is generated at predetermined intervals;
a memory configured to store the received control information; and
a processor configured to control the vehicle based on the received control information, the processor configured to complement a loss in control information which is to be received at a next control time based on the control information stored in the memory when the loss in the control information which is to be received at the next control time has been detected.

2. The control device according to claim 1, wherein:
the control information received from the information processing device is generated based on first target information on a first target operation in a future, which is to be performed by the vehicle, which is stored in the information processing device; and
the processor is configured to control the vehicle such that an operation of the vehicle becomes close to the first target operation based on the received control information.

3. The control device according to claim 2, wherein
the processor is configured to control the vehicle such that the operation of the vehicle becomes close to a second target operation instead of the first target operation without using the control information which is to be received at the next control time when second target information on the second target operation in the future which is to be performed by the vehicle prior to the first target operation is generated or received.

4. The control device according to claim 2, wherein:
the memory is configured to store the first target information; and
the processor is configured to complement the loss based on the control information stored in the memory and the first target information stored in the memory.

5. The control device according to claim 1, wherein
the processor is configured to complement the loss by extrapolation based on a plurality of pieces of the control information stored in the memory.

6. The control device according to claim 1, wherein
the processor is configured to complement the loss based on a plurality of pieces of the control information stored in the memory using an AI.

7. A non-transitory recording medium storing a program causing a control device to perform operations, the control device being mounted in a vehicle, the operations comprising:
receiving control information from an information processing device at a control time which is generated at predetermined intervals;
storing the received control information;
controlling the vehicle based on the received control information; and
complementing a loss in control information which is to be received at a next control time based on the stored control information when the loss in the control information which is to be received at the next control time has been detected.

8. A control method for a control device which is mounted in a vehicle, the control method comprising:
receiving control information from an information processing device at a control time which is generated at predetermined intervals;
storing the received control information;
controlling the vehicle based on the received control information; and
complementing a loss in control information which is to be received at a next control time based on the stored control information when the loss in the control information which is to be received at the next control time has been detected.
